(19) United States
(12) Patent Application Publication
(10) Pub. No.: US 2023/0132492 A1
(43) Pub. Date: May 4, 2023

(54) ADDITIVE MANUFACTURING DEVICE AND BLOWING NOZZLE

(71) Applicant: MITSUBISHI HEAVY INDUSTRIES, LTD., Tokyo (JP)

(72) Inventors: Koki ITO, Tokyo (JP); Jiro YONEDA, Tokyo (JP); Yoshinao KOMATSU, Tokyo (JP)

(73) Assignee: MITSUBISHI HEAVY INDUSTRIES, LTD., Tokyo (JP)

(21) Appl. No.: 17/965,338

(22) Filed: Oct. 13, 2022

(30) Foreign Application Priority Data
Nov. 4, 2021 (JP) 2021-180163

(51) Int. Cl. B22F 12/70; B33Y 30/00; B33Y 40/00; B22F 12/00

(52) U.S. Cl. CPC B22F 12/70; B33Y 30/00; B33Y 40/00; B22F 12/38

(57) ABSTRACT

An additive manufacturing device of the present disclosure includes a bottom portion having an additive manufacturing area on which an additive manufacturing article is additively manufactured, a ceiling portion positioned above the bottom portion and having a blowing part for an inert gas, a side portion standing upward from a side end portion of the bottom portion, and a discharge port of the inert gas, in which under a condition where a first direction is oriented from the additive manufacturing area toward the discharge port in a direction parallel to the bottom portion and a second direction is oriented across the first direction in the direction parallel to the bottom portion, a first width of the blowing part in the second direction is larger than a second width of the blowing part in the first direction and is equal to or larger than a third width of the additive manufacturing area in the second direction.

### BACKGROUND OF THE INVENTION

### Field of the Invention

The present disclosure relates to an additive manufacturing device and a blowing nozzle.

Priority is claimed on Japanese Patent Application No. 2021-180163, filed Nov. 4, 2021, the content of which is incorporated herein by reference.

### Description of Related Art

Japanese Unexamined Patent Application, First Publication No. 2016-006215 discloses an additive manufacturing device including a chamber having an additive manufacturing space covering an additive manufacturing region and filled with an inert gas having a predetermined concentration, and a fume diffusion part attached to an upper surface of the chamber. In this additive manufacturing device, the fume diffusion part includes a housing having an opening that is as small as possible to such an extent that it does not block laser light irradiated to the additive manufacturing region, and an inert gas supply path that fills the inside of the housing with an inert gas of the same type as the inert gas in the additive manufacturing space. Thereby, the inert gas can be ejected from the above-described opening to form a laminar flow of the inert gas along an irradiation path of the laser light, and thereby fumes can be removed from the irradiation path. The above-described opening is circular and supplies the inert gas all around the opening.

### SUMMARY OF THE INVENTION

However, in the additive manufacturing device described in Japanese Unexamined Patent Application, First Publication No. 2016-006215, an inert gas ejected downward from the above-described opening collides with an inner side surface of the chamber and generates a circulating flow. As a result, there is concern that fumes will be caught in the circulating flow and will not be sufficiently discharged from the inside of the chamber. If biasing in fume removal performance occurs in the chamber, laser light may be blocked by the fumes in a region in which the fumes remain, sufficient heat cannot be applied to a material powder, and thereby the quality of additive manufacturing may deteriorate. Therefore, there is a problem that variations in quality of additive manufacturing are caused.

The present disclosure has been made to solve the above problems, and an objective thereof is to provide an additive manufacturing device and a blowing nozzle capable of suppressing variations in quality of additive manufacturing.

In order to solve the above-described problems, an additive manufacturing device according to the present disclosure includes a bottom portion having an additive manufacturing area on which an additive manufacturing article is additively manufactured, a ceiling portion positioned above the bottom portion and having a blowing part for an inert gas, a side portion standing upward from a side end portion of the bottom portion, and a discharge port of the inert gas, in which under a condition where a first direction is oriented from the additive manufacturing area toward the discharge port in a direction parallel to the bottom portion and a second direction is oriented across the first direction in the direction parallel to the bottom portion, a first width of the blowing part in the second direction is larger than a second width of the blowing part in the first direction and is equal to or larger than a third width of the additive manufacturing area in the second direction.

An additive manufacturing device according to the present disclosure includes a bottom portion having an additive manufacturing area on which an additive manufacturing article is additively manufactured, a ceiling portion positioned above the bottom portion and having a blowing part for an inert gas, a side portion standing upward from a side end portion of the bottom portion, and a discharge port of the inert gas, in which under a condition where a first direction is oriented from the additive manufacturing area toward the discharge port in a direction parallel to the bottom portion and a second direction is oriented across the first direction in the direction parallel to the bottom portion, a first width of the blowing part in the second direction is larger than a second width of the blowing part in the first direction and is equal to or larger than a third width of the additive manufacturing article in the second direction.

An additive manufacturing device according to the present disclosure includes a bottom portion having an additive manufacturing area on which an additive manufacturing article is additively manufactured, a ceiling portion positioned above the bottom portion and having a blowing part for an inert gas and a first laser irradiation window, a side portion standing upward from a side end portion of the bottom portion, and a discharge port of the inert gas, in which under a condition where a first direction is oriented from the additive manufacturing area toward the discharge port in a direction parallel to the bottom portion and a second direction is oriented across the first direction in the direction parallel to the bottom portion, a first width of the blowing part in the first direction is smaller than a second width of the first laser irradiation window in the first direction, and a width of the blowing part in the second direction is larger than a third width of the first laser irradiation window in the second direction.

A blowing nozzle according to the present disclosure is attachable to an additive manufacturing device and includes a first end portion having an introduction part of an inert gas, and a second end portion positioned on a side opposite to the first end portion and including a blowing part for the inert gas, in which, under a condition where a first direction is oriented in a direction parallel to the second end portion and a second direction is oriented across the first direction in the direction parallel to the second end portion, the blowing nozzle includes a flat part extending in the second direction at least at the second end portion, and a first width of the blowing part in the second direction is larger than a second width of the blowing part in the first direction.

According to the additive manufacturing device and the blowing nozzle of the present disclosure, variations in quality of additive manufacturing can be suppressed.

### BRIEF DESCRIPTION OF THE DRAWINGS

FIG. 1 is a perspective view of an additive manufacturing device according to a first embodiment of the present disclosure.

FIG. 2 is a plan view of a ceiling portion according to the first embodiment of the present disclosure.

FIG. 3 is a view illustrating a flow of an inert gas according to the first embodiment of the present disclosure.

FIG. 4 is a perspective view of an additive manufacturing device according to a modified example of the first embodiment of the present disclosure.

FIG. 5 is a plan view of a ceiling portion according to a second embodiment of the present disclosure.

FIG. 6 is a plan view of a ceiling portion according to a third embodiment of the present disclosure.

FIG. 7 is a perspective view of an additive manufacturing device according to a fourth embodiment of the present disclosure.

FIG. 8 is a perspective view of a blowing nozzle according to the fourth embodiment of the present disclosure.

FIG. 9 is a plan view of a ceiling portion according to the fourth embodiment of the present disclosure.

FIG. 10 is a cross-sectional view in a second direction of the blowing nozzle according to the fourth embodiment of the present disclosure.

FIG. 11 is a side view of an additive manufacturing device according to a fifth embodiment of the present disclosure from a first direction.

FIG. 12 is a plan view of a rectifying member according to the fifth embodiment of the present disclosure from below.

### DETAILED DESCRIPTION OF THE INVENTION

### First Embodiment

(Additive Manufacturing Device)

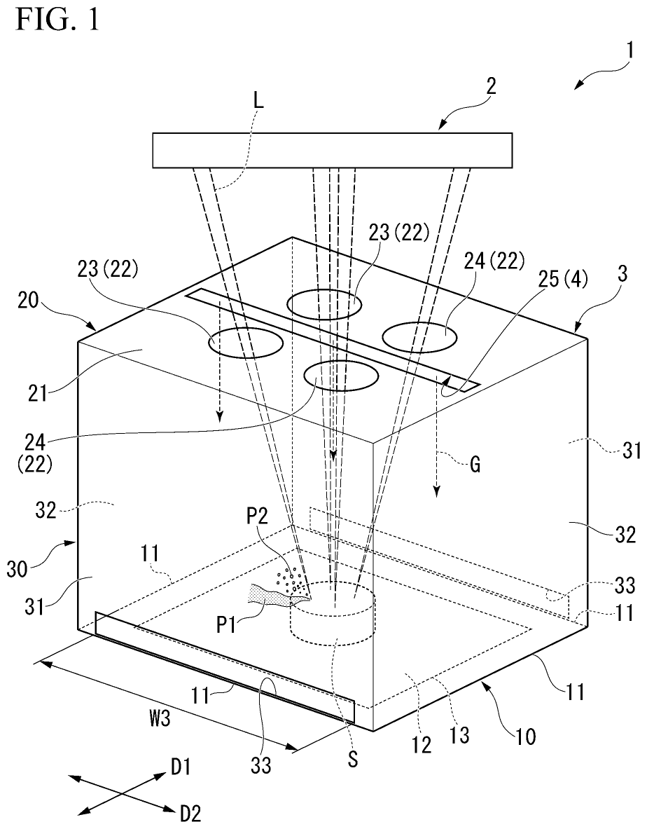

Hereinafter, an additive manufacturing device 1 according to a first embodiment of the present disclosure will be described with reference to FIGS. 1 to 3.

The additive manufacturing device 1 illustrated in FIG. 1 is, for example, a so-called powder head-type 3D printer. The additive manufacturing device 1 additively manufactures an additive manufacturing article S using a material powder as a raw material. More specifically, the additive manufacturing device 1 irradiates a material powder of a metal with laser light L to sinter it and form a sintered layer, and laminates the sintered layer to form the additive manufacturing article S.

As illustrated in FIG. 1, the additive manufacturing device 1 includes a laser irradiation unit 2 and a chamber 3. Further, the additive manufacturing device 1 includes a material supply unit, a control unit, and the like (not illustrated) in addition to the laser irradiation unit 2 and the chamber 3. Since various well-known devices can be used for this material supply unit, control unit, and the like, detailed description thereof will be omitted here. Also, in FIG. 1, the laser irradiation unit 2 and the chamber 3 are illustrated in a simplified manner so that the description can be better understood. In FIG. 1, for example, a taking-out port or the like of the additive manufacturing article S is omitted.

The laser irradiation unit 2 includes a laser light source (not illustrated) and an irradiation control unit (not illustrated). The laser light source illuminates the laser light L. The laser light L may be any one as long as it can sinter the material powder. The laser light L is, for example, a CO₂ laser, a fiber laser, an yttrium aluminum garnet (YAG) laser, or the like. The laser light source emits the generated laser light L downward. The irradiation control unit controls irradiation of the laser light L to move the laser light L two-dimensionally along a plane parallel to a horizontal direction.

(Chamber)

The chamber 3 is disposed below the laser irradiation unit 2. In the chamber 3, the additive manufacturing article S is additively manufactured. The chamber 3 includes a bottom portion 10, a ceiling portion 20, and a side portion 30.

(Bottom Portion)

The bottom portion 10 lies along the horizontal direction. A first direction D1 is one of directions parallel to the bottom portion 10. A second direction D2 is the other of the directions parallel to the bottom portion 10 and is oriented across (for example, perpendicular to) the first direction D1.

The bottom portion 10 is formed in a rectangular shape in a plan view (that is, when viewed from above). The bottom portion 10 has four side end portions 11. The four side end portions 11 extend in one of the first direction D1 and the second direction D2. The bottom portion 10 has a stage 12 at a central part. The stage 12 is formed in a rectangular shape in a plan view. Each edge of the stage 12 extends in one of the first direction D1 and the second direction D2. The stage 12 is able to be raised and lowered vertically. An upper surface of the stage 12 is an additive manufacturing area 13 on which the additive manufacturing article S is additively manufactured. Further, “additive manufacturing area” described in the present disclosure is not limited to a stage that can be raised and lowered and may be part of the bottom portion 10 at a fixed position. An “additive manufacturing area” as used in the present disclosure means an area in the bottom portion 10 where the additive manufacturing article S is additively manufactured. For example, the “additive manufacturing area” means an area of the bottom portion 10 that is irradiated with the laser light L.

(Ceiling Portion)

The ceiling portion 20 is positioned above the bottom portion 10. The ceiling portion 20 includes a ceiling portion main body 21, one or more (for example, a plurality of) laser irradiation windows 22, and a blowing part 4.

(Ceiling Portion Main Body)

The ceiling portion main body 21 vertically partitions a space inside the chamber 3. The ceiling portion main body 21 is formed in a plate shape extending in the horizontal direction. The ceiling portion main body 21 is formed on the side portion 30 so as to cover the entire additive manufacturing area 13.

(Laser Irradiation Window)

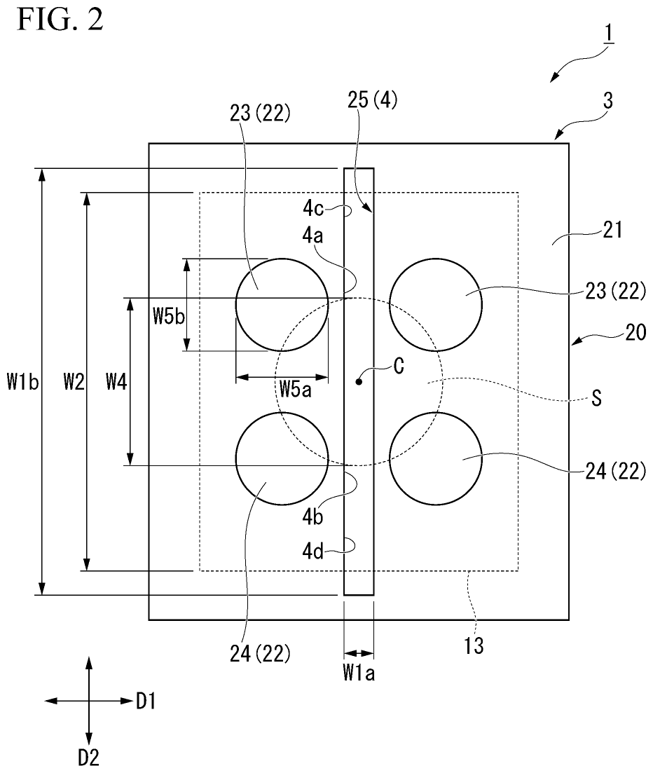

As illustrated in FIG. 2, a total of four laser irradiation windows 22 are provided at a central part of the ceiling portion main body 21. The laser irradiation windows 22 each face the laser irradiation unit 2 in a vertical direction. The laser irradiation window 22 is formed of a material that can transmit the laser light L (see FIG. 1) output from the laser irradiation unit 2. When the laser light L is illuminated from a fiber laser or a YAG laser, the laser irradiation window 22 is formed of, for example, quartz glass. The laser irradiation windows 22 are formed to have the same shape and size. The laser irradiation window 22 is formed in a disc shape. A plate thickness direction of the laser irradiation window 22 coincides with the vertical direction. For example, the four laser irradiation windows 22 are disposed so that center points thereof draw a rectangle in a plan view. The four laser irradiation windows 22 are positioned inside the additive manufacturing area 13 in a plan view.

The four laser irradiation windows 22 include two first laser irradiation windows 23 and two second laser irradiation windows 24 aligned in the second direction D2. The two first laser irradiation windows 23 are aligned in the first direction D1. The two second laser irradiation windows 24 are aligned in the first direction D1. Further, a disposition of the laser irradiation windows 22 is not limited to the above-described example. For example, the first laser irradiation windows 23 and the second laser irradiation windows 24 are not limited to the disposition in which they are completely aligned in the second direction D2. The first laser irradiation windows 23 and the second laser irradiation windows 24 may be disposed offset from each other in the first direction D1 so that they are partially aligned in the second direction D2.

(Blowing Part)

The blowing part 4 is a blowing part for an inert gas G. The blowing part 4 is provided in the ceiling portion main body 21. The blowing part 4 blows out the inert gas G from the ceiling portion main body 21 toward the bottom portion 10 (that is, downward). The inert gas G is a gas that does not substantially react with the material powder. The inert gas G is, for example, nitrogen gas, argon gas, helium gas, or the like. In the present embodiment, the blowing part 4 is an opening (blowing opening 25) that opens in the ceiling portion main body 21. For example, the blowing part 4 is provided at a central part of the ceiling portion main body 21.

As illustrated in FIG. 2, the blowing opening 25 is formed in a rectangular shape extending in the second direction D2 in a plan view. In the present embodiment, a width W1b of the blowing part 4 in the second direction D2 is larger than a width W1a of the blowing part 4 in the first direction D1 and is equal to or larger than a width W2 of the additive manufacturing area 13 in the second direction D2.

From another point of view, the width W1b of the blowing part 4 in the second direction D2 is equal to or larger than a width W4 of the additive manufacturing article S in the second direction D2.

Also, from another point of view, the width W1a of the blowing part 4 in the first direction D1 is smaller than a width W5a of the laser irradiation window 22 (for example, the first laser irradiation window 23) in the first direction D1. The width W1b of the blowing part 4 in the second direction D2 is larger than a width W5b of the laser irradiation window 22 (for example, the first laser irradiation window 23) in the second direction D2.

In the present embodiment, the blowing part 4 is provided between a plurality of laser irradiation windows 22. More specifically, the blowing part 4 is positioned between the two first laser irradiation windows 23 and between the two second laser irradiation windows 24. In the present embodiment, the blowing part 4 includes a first portion 4a aligned with the first laser irradiation windows 23 in the first direction D1 and a second portion 4b aligned with the second laser irradiation windows 24 in the first direction D1 in a plan view.

Furthermore, the blowing part 4 has a third portion 4c and a fourth portion 4d. The third portion 4c is a portion positioned farther away than the first laser irradiation window 23 in the second direction D2 when viewed from a center C of the additive manufacturing area 13 in a plan view. On the other hand, the fourth portion 4d is a portion positioned farther away than the second laser irradiation window 24 in the second direction D2 when viewed from the center C of the additive manufacturing area 13 in a plan view.

(Side Portion)

Returning to FIG. 1, the side portion 30 will be described. The side portion 30 is provided to stand upward from the side end portion 11 of the bottom portion 10. The side portion 30 includes a pair of first side portions 31 facing in the first direction D1 and a pair of second side portions 32 facing in the second direction D2. The pair of first side portions 31 each include a discharge port 33 of the inert gas G.

(Discharge Port)

The discharge port 33 is provided at a lower part of the first side portion 31. A pair of discharge ports 33 are provided to face each other in the first direction D1. The pair of discharge ports 33 are formed to have the same shape and size. The discharge ports 33 are each formed in a rectangular shape extending in the second direction D2. The discharge port 33 opens toward the additive manufacturing area 13. The discharge port 33 extends along the additive manufacturing area 13. A width W3 of the discharge port 33 in the second direction D2 is substantially the same as the width W2 of the additive manufacturing area 13 in the second direction D2. A direction from the additive manufacturing area 13 toward the discharge port 33 parallel to the bottom portion 10 coincides with the first direction D1.

(Operation and Effects)

When additive manufacturing is performed using the additive manufacturing device 1 described above, first, a material powder is laid flat on the additive manufacturing area 13 to form a layer of the material powder. The laser light L is applied to the material powder laid on the additive manufacturing area 13. The material powder is sintered by the laser light L. Thereby, a first sintered layer is formed in the additive manufacturing area 13. Thereafter, the stage 12 is lowered by the thickness of one sintered layer. The material powder is laid on the first sintered layer, and a second sintered layer is formed in the same procedure. This procedure is repeated to laminate a plurality of sintered layers. Adjacent sintered layers are strongly fixed to each other. When the plurality of formed sintered layers are fixed, additive manufacturing of the additive manufacturing article S is completed. After the additive manufacturing of the additive manufacturing article S, unsintered material powder is removed.

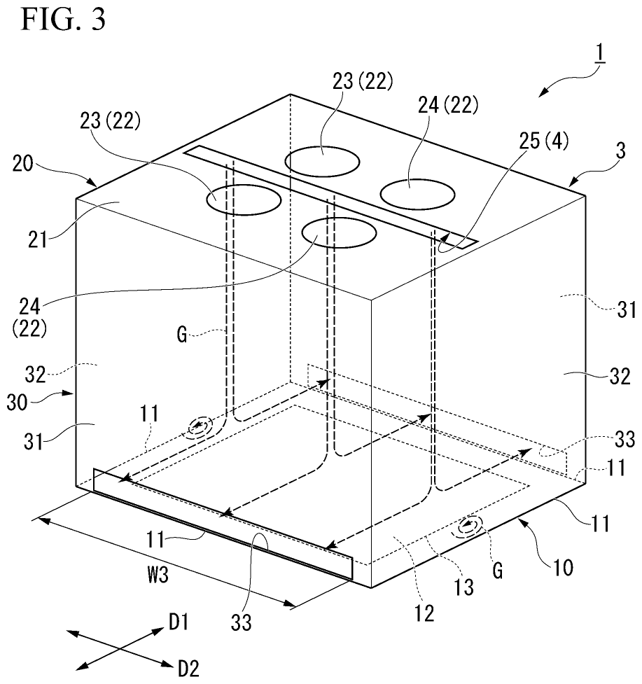

If additive manufacturing is performed as described above, when the material powder is irradiated with the laser light L, the heat of the laser light L causes fumes P1 and spatters P2 to be generated from the material powder. The fumes P1 and the spatters P2 block the laser light L, and this becomes a cause of deterioration in performance of the additive manufacturing device 1. Therefore, it is necessary to remove the fumes P1 and the spatters P2 from the inside of the chamber 3. A method of removing the fumes P1 and the spatters P2 will be described below with reference to FIG. 3.

(Method of Removing Fumes and Spatters)

As illustrated in FIG. 3, the blowing part 4 blows out the inert gas G downward toward the additive manufacturing area 13. A flow of the inert gas G blown out from the blowing part 4 forms a two-dimensional flow along a virtual plane extending in the vertical direction and a uniform flow in the second direction D2. The inert gas G collides with a central part of the additive manufacturing area 13. When the inert gas G collides with the additive manufacturing area 13, it flows from the central part of the additive manufacturing area 13 toward an outer side in the first direction D1. At this time, the inert gas G flows along the additive manufacturing area 13. The flow of the inert gas G along the additive manufacturing area 13 becomes a uniform flow in the first direction D1 and the second direction D2. The flow of the inert gas G along the additive manufacturing area 13 occurs in an area wider than that of the additive manufacturing area 13 including the entire region of the additive manufacturing area 13. Thereafter, the inert gas G is discharged to the outside of the chamber 3 from the discharge port 33.

Due to the flow of the inert gas G described above, the fumes P1 and the spatters P2 are quickly discharged to the outside of the chamber 3 from the discharge port 33. In this manner, the fumes P1 and the spatters P2 are removed from the inside of the chamber 3.

Here, as a comparative example, a configuration in which a circular or relatively small oval-shaped blowing part for the inert gas G is provided in the ceiling portion main body 21 may be conceived. In such a configuration, the inert gas G ejected downward from the blowing part collides with the additive manufacturing area 13 and then flows along the additive manufacturing area 13 to spread all around. As a result, the inert gas G collides with the second side portion 32 and generates a circulating flow in the vicinity of the second side portion 32 in which the discharge port 33 is not provided. As a result, the fumes P1 and the spatters P2 may be caught in the circulating flow and may not be sufficiently discharged from the inside of the chamber 3.

On the other hand, the width W1b of the blowing part 4 in the second direction D2 is larger than the width W1a of the blowing part 4 in the first direction D1 and is equal to or larger than the width W2 of the additive manufacturing area 13 in the second direction D2.

Thereby, in the blowing part 4, the flow of the inert gas G can be made uniform in the second direction D2 while being aligned in parallel. The flow of the inert gas G blown out from the blowing part 4 has a two-dimensional and uniform flow along a virtual plane extending in the vertical direction. Further, the inert gas G can be made to collide with the entire additive manufacturing area 13 in the second direction D2. The inert gas G that has collided with the additive manufacturing area 13 flows in the first direction D1 along the additive manufacturing area 13 and is discharged from the discharge port 33. The flow of the inert gas G along the additive manufacturing area 13 has a uniform flow. The flow of the inert gas G suppresses generation of a circulating flow that rolls upward along the second side portion 32 from the bottom portion 10. Therefore, the inert gas G is guided to the discharge port 33 without remaining. Thereby, the fumes P1 and the spatters P2 being caught in the circulating flow can be suppressed. The fumes P1 and the spatters P2 can be discharged from the discharge port 33 by the flow of the inert gas G along the additive manufacturing area 13. Therefore, the fumes P1 and the spatters P2 can be removed without being biased within the additive manufacturing area 13, and the fumes P1 and the spatters P2 blocking the laser light L irradiated to the additive manufacturing article S can be evenly suppressed within the additive manufacturing area 13. Therefore, variations in quality of additive manufacturing can be suppressed.

Also, since the flow of the inert gas G along the additive manufacturing area 13 has a uniform flow, supply and exhaust of the inert gas G are performed uniformly and quickly on the additive manufacturing area 13. Therefore, the fumes P1 and the spatters P2 can be satisfactorily discharged by the flow of the inert gas G.

Further, an interference vortex of the inert gas G may occur outside the collision position of the inert gas G in the second direction D2. In the present embodiment, the width W1b of the blowing part 4 in the second direction D2 is equal to or larger than the width W2 of the additive manufacturing area 13 in the second direction D2. Therefore, the interference vortex can be positioned outside the additive manufacturing area 13. Thereby, the fumes P1 and the spatters P2 caught in the interference vortex blocking the laser light L irradiated to the additive manufacturing article S can be suppressed.

In the present embodiment, the blowing part 4 is an opening (blowing opening 25) provided in the ceiling portion main body 21. Thereby, the blowing part 4 can be formed by simple processing of simply forming the blowing opening 25 in the ceiling portion main body 21. Therefore, a manufacturing process of the additive manufacturing device 1 can be reduced.

In the present embodiment, the blowing part 4 is provided between the plurality of laser irradiation windows 22. Therefore, the laser light L irradiated from the laser irradiation windows 22 is not interfered by being blocked by the blowing part 4 or the like. Thereby, the blowing part 4 can be provided without changing a structure of the laser irradiation windows 22 or the like.

### Modified Example of First Embodiment

The discharge port 33 of the inert gas G may be provided in the bottom portion 10. In this case, the discharge port 33 is disposed on an outer side of the additive manufacturing area 13 in the first direction D1.

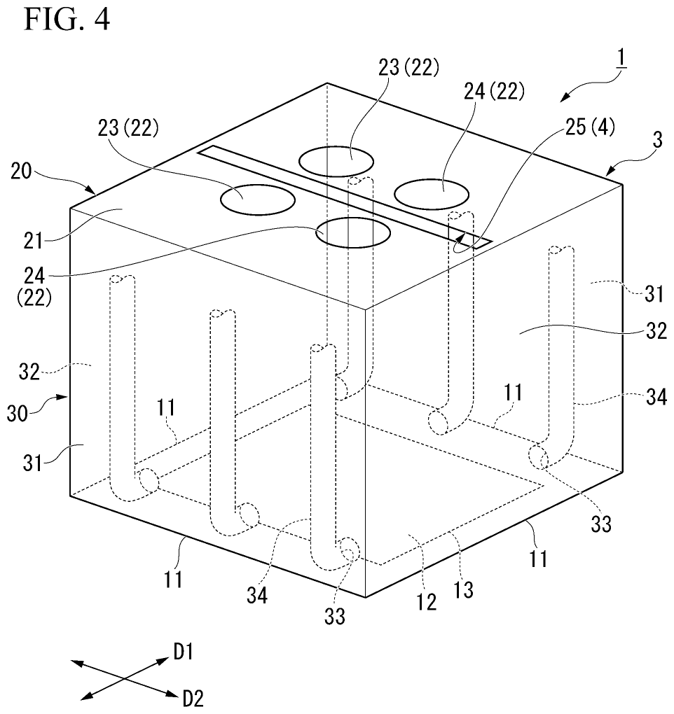

Also, as illustrated in FIG. 4, the additive manufacturing device 1 may include a flow path member 34 having the discharge port 33. The flow path member 34 is, for example, a pipe provided in the first side portion 31. The flow path member 34 extends in the vertical direction along the first side portion 31. A plurality of flow path members 34 are provided at intervals in the second direction D2. A lower end portion of each of the flow path members 34 bends inward in the first direction D1 in the vicinity of the bottom portion 10 and opens toward the additive manufacturing area 13. A lower opening of the flow path member 34 serves as the discharge port 33 of the inert gas G. The inert gas G is introduced into the inside of the flow path member 34 from the discharge port 33, flows upward through the flow path member 34, and is discharged to the outside of the chamber 3 through an upper opening (not illustrated) of the flow path member 34.

Further, the flow path member 34 is not limited to a pipe, and may be, for example, a fan or the like that allows the inside and outside of the chamber 3 to communicate.

### Second Embodiment

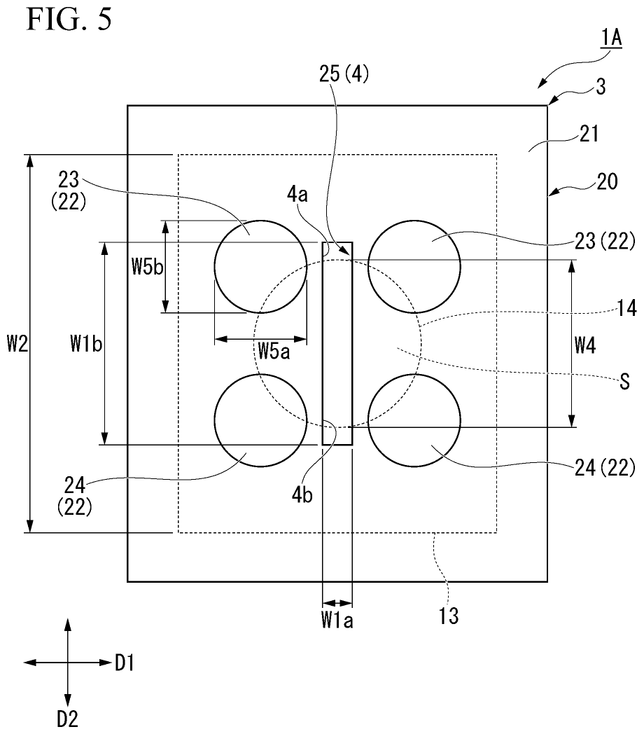

Hereinafter, an additive manufacturing device 1A according to a second embodiment of the present disclosure will be described with reference to FIG. 5. In the second embodiment, components the same as those in the first embodiment will be denoted by the same reference signs and detailed description thereof will be omitted. Configurations of the second embodiment other than those described below are the same as the configurations of the first embodiment.

As illustrated in FIG. 5, there are cases in which an additive manufacturing area 13 is partially used in additive manufacturing. Hereinafter, a portion of the additive manufacturing area 13 that is actually used for additive manufacturing of an additive manufacturing article S is referred to as a use area 14. In the present embodiment, a width W1b of a blowing part 4 in a second direction D2 is larger than a width W1a of the blowing part 4 in a first direction D1 and is equal to or larger than a width of the use area 14 of the additive manufacturing area 13 in the second direction D2. That is, the width W1b of the blowing part 4 in the second direction D2 is equal to or larger than the width W4 of the additive manufacturing article S in the second direction D2. In the present embodiment, the width W1b of the blowing part 4 in the second direction D2 is smaller than the width W2 of the additive manufacturing area 13 in the second direction D2.

(Operation and Effects)

In the present embodiment, the width W1b of the blowing part 4 in the second direction D2 is larger than the width W1a of the blowing part 4 in the first direction D1 and is equal to or larger than the width W4 of the additive manufacturing article S in the second direction D2.

Thereby, in the blowing part 4, a flow of an inert gas G can be made uniform in the second direction D2 while being aligned in parallel. The flow of the inert gas G blown out from the blowing part 4 has a two-dimensional and uniform flow along a virtual plane extending in the vertical direction. Further, the inert gas G can be made to collide with the entire of the additive manufacturing article S in the second direction D2. The inert gas G that has collided with the additive manufacturing article S flows in the first direction D1 along the additive manufacturing area 13 and is discharged from a discharge port 33. The flow of the inert gas G along the additive manufacturing area 13 has a uniform flow at least in the use area 14. Such a flow of inert gas G suppresses generation of a circulating flow that rolls upward along a second side portion 32 from a bottom portion 10. Therefore, the inert gas G is guided to the discharge port 33 without remaining. Thereby, fumes P1 and spatters P2 being caught in the circulating flow can be suppressed. Fumes P1 and spatters P2 can be discharged from the discharge port 33 by the flow of the inert gas G along the additive manufacturing area 13. Therefore, the fumes P1 and the spatters P2 can be removed without being biased at least within the use area 14, and the fumes P1 and the spatters P2 blocking laser light L irradiated to the additive manufacturing article S can be evenly suppressed at least within the use area 14. Therefore, variations in quality of additive manufacturing can be suppressed.

Also, since the flow of the inert gas G along the additive manufacturing area 13 has a uniform flow at least within the use area 14, supply and exhaust of the inert gas G are performed uniformly and quickly at least on the use area 14. Therefore, the fumes P1 and the spatters P2 can be satisfactorily discharged by the flow of the inert gas G.

Also, the width W1b of the blowing part 4 in the second direction D2 is equal to or larger than the width W4 of the additive manufacturing article S in the second direction D2. Therefore, an interference vortex can be positioned outside the additive manufacturing article S, that is, outside the use area 14. Thereby, the fumes P1 and the spatters P2 caught in the interference vortex blocking the laser light L irradiated to the additive manufacturing article S can be suppressed.

### Third Embodiment

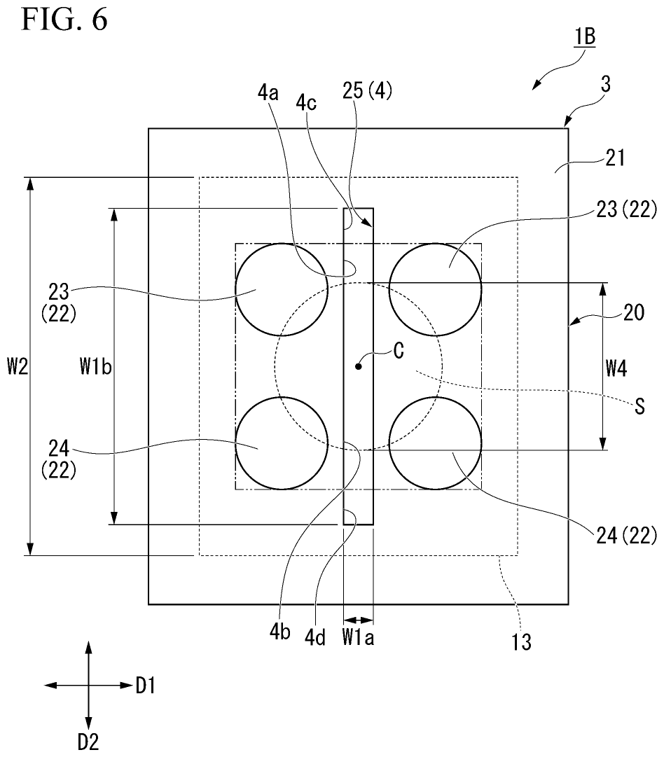

Hereinafter, an additive manufacturing device 1B according to a third embodiment of the present disclosure will be described with reference to FIG. 6. In the third embodiment, components the same as those in the first embodiment will be denoted by the same reference signs and detailed description thereof will be omitted. Configurations of the third embodiment other than those described below are the same as the configurations of the first embodiment.

As illustrated in FIG. 6, a width W1a of a blowing part 4 in a first direction D1 is smaller than a width W5a of a laser irradiation window 22 (for example, a first laser irradiation window 23) in the first direction D1, and a width W1b of the blowing part 4 in a second direction D2 is larger than a width W5b of the laser irradiation window 22 (for example, the first laser irradiation window 23) in the second direction D2. In the present embodiment, the width W1b of the blowing part 4 in the second direction D2 is larger than a width W4 of an additive manufacturing article S in the second direction D2 and smaller than a width W2 of an additive manufacturing area 13 in the second direction D2.

In the present embodiment, the blowing part 4 includes a first portion 4a aligned with the first laser irradiation window 23 in the first direction D1 and a second portion 4b aligned with the second laser irradiation window 24 in the first direction D1 in a plan view.

Furthermore, the blowing part 4 has a third portion 4c and a fourth portion 4d. The third portion 4c is a portion positioned farther away than the first laser irradiation window 23 in the second direction D2 when viewed from a center C of the additive manufacturing area 13 in a plan view. On the other hand, the fourth portion 4d is a portion positioned farther away than the second laser irradiation window 24 in the second direction D2 when viewed from the center C of the additive manufacturing area 13 in a plan view.

(Operation and Effects)

In the present embodiment, the width W1a of the blowing part 4 in the first direction D1 is smaller than the width W5a of the first laser irradiation window 23 in the first direction D1. The width W1b of the blowing part 4 in the second direction D2 is larger than the width W5b of the first laser irradiation window 23 in the second direction D2.

Thereby, in the blowing part 4, a flow of an inert gas G can be made uniform in the second direction D2 while being aligned in parallel. The flow of the inert gas G blown out from the blowing part 4 has a two-dimensional and uniform flow along a virtual plane extending in the vertical direction. Further, since the inert gas G can be blown out from a wider range in the second direction D2 than the width W5b of the first laser irradiation window 23 in the second direction D2, the inert gas G can be made to collide with a wider range in the second direction D2 than an area of the additive manufacturing area 13 that overlaps the first laser irradiation window 23. The inert gas G that has collided with the additive manufacturing area 13 flows in the first direction D1 along the additive manufacturing area 13 and is discharged from a discharge port 33. The flow of the inert gas G along the additive manufacturing area 13 has a uniform flow at least in the area of the additive manufacturing area 13 that overlaps the first laser irradiation window 23. The flow of the inert gas G suppresses generation of a circulating flow that rolls upward along a side portion 30 from a bottom portion 10. Therefore, the inert gas G is guided to the discharge port 33 without remaining. Thereby, the occurrence of fumes P1 and spatters P2 being caught in the circulating flow can be suppressed. Fumes P1 and spatters P2 can be discharged from the discharge port 33 by the flow of the inert gas G along the additive manufacturing area 13. Therefore, the fumes P1 and the spatters P2 can be removed without being biased at least within the area of the additive manufacturing area 13 that overlaps the first laser irradiation window 23, and the fumes P1 and the spatters P2 blocking laser light L irradiated to the additive manufacturing article S can be evenly suppressed at least within the area of the additive manufacturing area 13 that overlaps the first laser irradiation window 23. Therefore, variations in quality of additive manufacturing can be suppressed.

Also, since the flow of the inert gas G along the additive manufacturing area 13 has a uniform flow at least within the area of the additive manufacturing area 13 that overlaps the first laser irradiation window 23, supply and exhaust of the inert gas G are performed uniformly and quickly at least on the area of the additive manufacturing area 13 that overlaps the first laser irradiation window 23. Therefore, the fumes P1 and the spatters P2 can be satisfactorily discharged by the flow of the inert gas G.

Also, the inert gas G can be made to collide with a wider range in the second direction D2 than the area of the additive manufacturing area 13 that overlaps the first laser irradiation window 23. Therefore, an interference vortex can be positioned outside the range of the additive manufacturing area 13 that overlaps the first laser irradiation window 23. Thereby, the fumes P1 and the spatters P2 caught in the interference vortex blocking the laser light L irradiated to the additive manufacturing article S can be suppressed.

In the present embodiment, the blowing part 4 includes the first portion 4a aligned with the first laser irradiation window 23 in the first direction D1 and the second portion 4b aligned with the second laser irradiation window 24 in the first direction D1 in a plan view. Thereby, the inert gas G can be blown out from a wide range corresponding to a region in which the plurality of laser irradiation windows 22 (the first laser irradiation window 23 and the second laser irradiation window 24) are provided. Therefore, the inert gas G can be made to collide with a wide range of the additive manufacturing area 13 corresponding to the plurality of laser irradiation windows 22. Therefore, the fumes P1 and the spatters P2 can be more satisfactorily discharged by the flow of the inert gas G along the additive manufacturing area 13.

### Fourth Embodiment

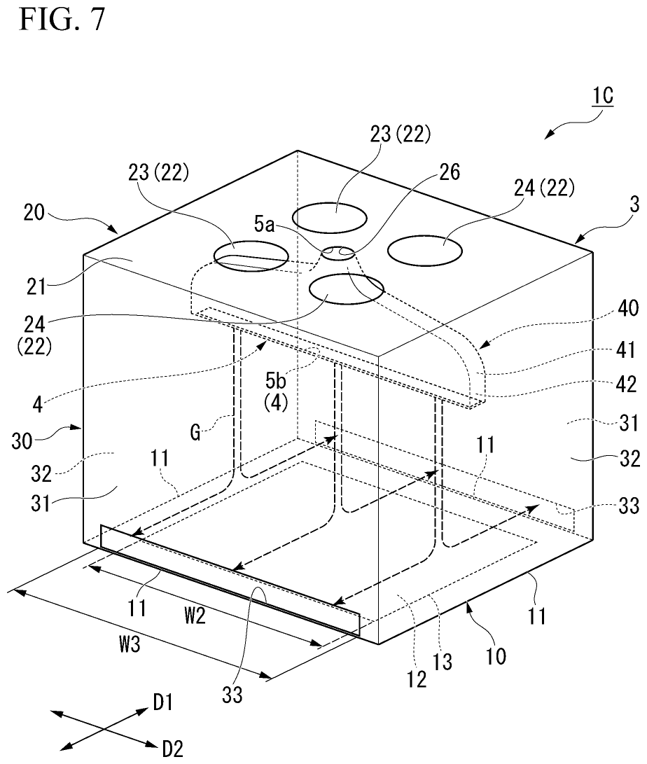

Hereinafter, an additive manufacturing device 1C according to a fourth embodiment of the present disclosure will be described with reference to FIGS. 7 to 9. In the fourth embodiment, components the same as those in the first embodiment will be denoted by the same reference signs and detailed description thereof will be omitted. Configurations of the fourth embodiment other than those described below are the same as the configurations of the first embodiment.

As illustrated in FIG. 7, in the present embodiment, a ceiling portion 20 includes a ceiling portion main body 21 and a blowing nozzle 40 extending downward from the ceiling portion main body 21. In the present embodiment, a blowing part 4 is an opening (blowing port 5b) that opens at a lower end portion 40b of the blowing nozzle 40.

Specifically, an attachment opening 26 to which the blowing nozzle 40 is attached is formed in the ceiling portion main body 21. The attachment opening 26 is provided at a central part of the ceiling portion main body 21 in a plan view. The attachment opening 26 is surrounded by four laser irradiation windows 22. The attachment opening 26 is formed in a circular shape in a plan view.

(Blowing Nozzle)

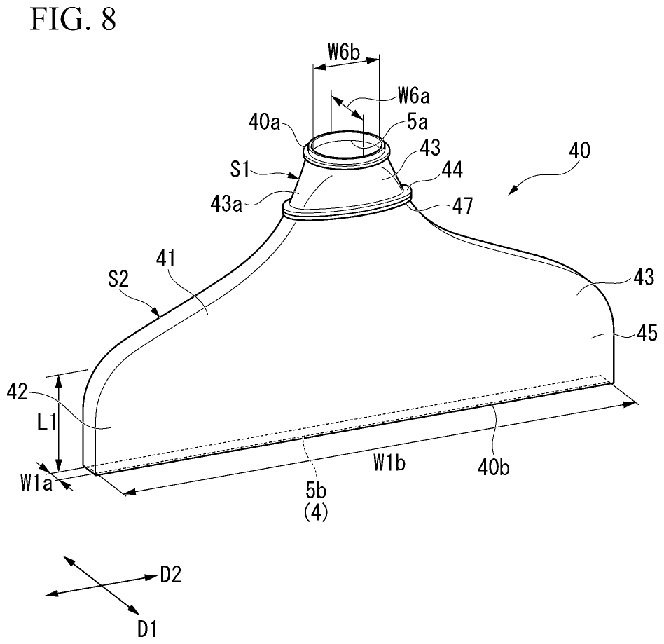

As illustrated in FIG. 8, the blowing nozzle 40 has an upper end portion (first end portion) 40a and the lower end portion (second end portion) 40b. The lower end portion 40b is positioned on a side opposite to the upper end portion 40a in an axial direction (vertical direction) of the blowing nozzle 40.

The blowing nozzle 40 is formed in a tubular shape with the upper end portion 40a and the lower end portion 40b opening. An opening of the upper end portion 40a of the blowing nozzle 40 is an introduction port (introduction part) 5a through which an inert gas G is introduced into the inside of the blowing nozzle 40. The introduction port 5a is formed in a circular shape. An opening of the lower end portion 40b of the blowing nozzle 40 is the blowing port 5b through which the inert gas G is blown out. The blowing port 5b opens downward. The blowing port 5b is parallel to the first direction D1 and the second direction D2 described above. The size of the blowing port 5b will be described later.

The upper end portion 40a of the blowing nozzle 40 is detachably attached to the ceiling portion main body 21. The introduction port 5a of the blowing nozzle 40 communicates with the attachment opening 26 of the ceiling portion main body 21. That is, the blowing nozzle 40 is attached to extend downward from the ceiling portion main body 21.

In one aspect, the blowing nozzle 40 includes an enlarged part 41 and an outlet part 42. The enlarged part 41 is a portion whose width in the second direction D2 becomes larger as it proceeds downward. For example, the enlarged part 41 is formed such that a cross-sectional shape thereof gradually changes as it proceeds downward from the introduction port 5a. The outlet part 42 is provided below the enlarged part 41.

The outlet part 42 extends downward with a fixed width in the second direction D2. That is, the width in the second direction D2 is not increased in the outlet part 42. The length L1 of the outlet part 42 in the vertical direction is larger than, for example, a width W1a of the blowing port 5b in the first direction D1. The outlet part 42 is a rectifying part that changes a flow of the inert gas G that is made to have a flow component in the second direction D2 while passing through the enlarged part 41 into a vertically downward flow. In the present embodiment, the blowing port 5b is provided at a lower end of the outlet part 42.

The width W1a of the blowing port 5b in the first direction D1 is smaller than a width W6a of the introduction port 5a in the first direction D1. A width W1b of the blowing port 5b in the second direction D2 is larger than a width W6b of the introduction port 5a in the second direction D2. The width W1b of the blowing port 5b in the second direction D2 is, for example, three times or more, and more specifically four times or more the width W6b of the introduction port 5a in the second direction D2.

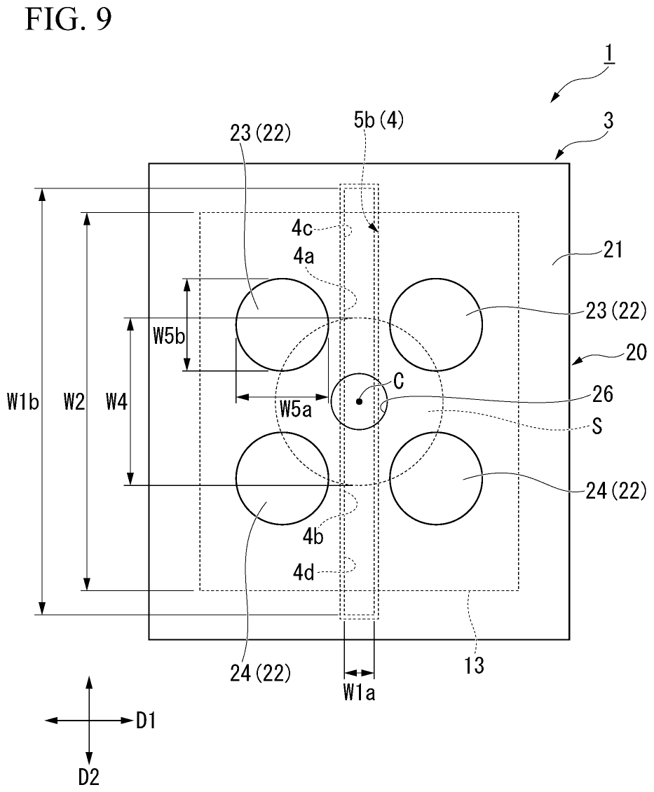

As illustrated in FIG. 9, in the present embodiment, the blowing port 5b is formed in a rectangular shape extending in the second direction D2 in a plan view. In the present embodiment, the width W1b of the blowing port 5b in the second direction D2 is larger than the width W1a of the blowing port 5b in the first direction D1 and is equal to or larger than a width W2 of an additive manufacturing area 13 in the second direction D2.

Further, a shape and size of the blowing port 5b are the same as a shape and size of the blowing part 4 (blowing opening 25) of the first embodiment. That is, “blowing part 4” in the description on the shape and size of the blowing part 4 in the first embodiment may be read as “blowing port 5b” in the description on the shape and size of the blowing port 5b.

Returning to FIG. 8, another part of the blowing nozzle 40 will be described. In the present embodiment, the blowing nozzle 40 includes a flat part 43. The flat part 43 is provided at least in the lower end portion 40b of the blowing nozzle 40. In the present embodiment, the flat part 43 is provided across at least part of the enlarged part 41 and the outlet part 42.

The flat part 43 is formed in a flat shape (hollow flat plate shape) extending in the second direction D2. The flat part 43 has an internal space with a constant width in the first direction D1. The flat part 43 is a rectifying part that straightens a flow of the inert gas G into a vertically downward flow when the inert gas G that has flowed therein from the introduction port 5a has a flow component in the first direction D1.

According to one aspect, the blowing nozzle 40 includes a first blowing nozzle S1 and a second blowing nozzle S2.

The first blowing nozzle S1 is a blowing nozzle that can be attached in exchange for, for example, a normal nozzle of the additive manufacturing device 1. That is, a fixing structure of the first blowing nozzle S1 with respect to the attachment opening 26 is the same as a fixing structure of a normal nozzle. Further, the first blowing nozzle S1 may be a normal nozzle (existing nozzle) itself of the additive manufacturing device 1.

In the present embodiment, the first blowing nozzle S1 includes a first blowing nozzle main body 43a and a flange 44. The first blowing nozzle main body 43a is formed in a tubular shape extending in the vertical direction and having both end portions in the axial direction opened. An upper opening of the first blowing nozzle main body 43a is the introduction port 5a of the inert gas G. The width of the first blowing nozzle main body 43a in the first direction D1 gradually decreases downward. The width of the first blowing nozzle main body 43a in the second direction D2 gradually increases downward. A lower opening of the first blowing nozzle main body 43a is formed in an elliptical shape extending in the second direction D2 in a plan view. The flange 44 is provided over the entire circumference of an outer circumferential surface of a lower end portion of the first blowing nozzle main body 43a. The flange 44 protrudes outward from the first blowing nozzle main body 43a.

The second blowing nozzle S2 is an additional nozzle (extended nozzle) attached to the first blowing nozzle S1. The second blowing nozzle S2 is attached to a lower end portion of the first blowing nozzle S1 and extends downward from the lower end portion of the first blowing nozzle S1. The blowing port 5b is provided at a lower end portion of the second blowing nozzle S2.

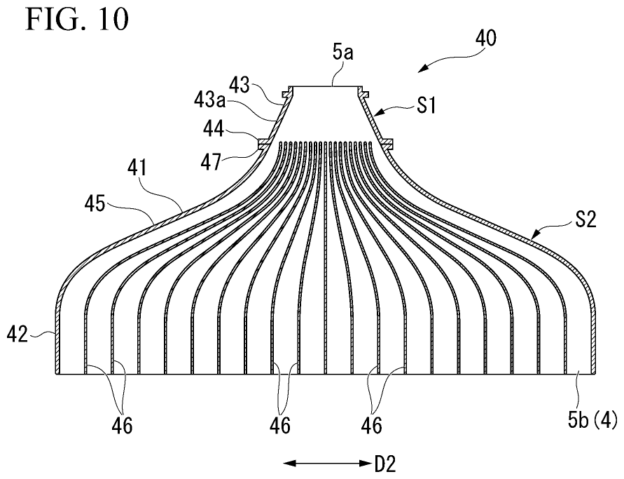

In the present embodiment, the second blowing nozzle S2 includes a second blowing nozzle main body (flat part main body) 45, a plurality of guide vanes 46 (see FIG. 10), and a flange 47.

The second blowing nozzle main body 45 has an outer shape formed in a flat shape extending in the vertical direction and in the second direction D2. The second blowing nozzle main body 45 includes the enlarged part 41, the outlet part 42, and the flat part 43 described above. An upper opening of the second blowing nozzle main body 45 is formed to have the same shape and size as a lower opening of the first blowing nozzle main body 43a and communicates with the lower opening of the first blowing nozzle main body 43a.

As illustrated in FIG. 10, the plurality of guide vanes 46 are provided inside the second blowing nozzle main body 45. The plurality of guide vanes 46 each extend in the vertical direction and are disposed to be aligned at regular intervals in the second direction D2. The guide vanes 46 each extend so that they are positioned outward in the second direction D2 downward. The intervals between the plurality of guide vanes 46 in the second direction D2 each increase downward. However, at a lower portion of the second blowing nozzle main body 45, intervals between the plurality of guide vanes 46 in the second direction D2 are constant. That is, the guide vanes 46 extend linearly in the vertical direction at the lower portion of the second blowing nozzle main body 45.

The flange 47 is provided over the entire circumference of an outer circumferential surface of an upper end portion of the second blowing nozzle main body 45 (see FIG. 8). The flange 47 protrudes outward from the second blowing nozzle main body 45. The flange 47 is connected to the flange 44 of the first blowing nozzle S1 from below.

(Operation and Effects)

In the present embodiment, the additive manufacturing device 1C includes the blowing nozzle 40 that can be attached to the ceiling portion main body 21. The blowing port 5b corresponding to the blowing part 4 (blowing opening 25) of the first embodiment is provided at the lower end portion of the blowing nozzle 40. Thereby, the additive manufacturing device 1C including the blowing port 5b can be obtained by attaching the blowing nozzle 40 to the ceiling portion main body 21. That is, the blowing nozzle 40 can be retrofitted into an existing apparatus.

In the present embodiment, the width W1b of the blowing port 5b in the second direction D2 is larger than the width W1a of the blowing port 5b in the first direction D1 and is equal to or larger than the width W2 of the additive manufacturing area 13 in the second direction D2. Thereby, the same operation and effects as those of the first embodiment can be exhibited.

In the present embodiment, the blowing nozzle 40 includes the flat part 43 extending in the second direction D2 at least at the lower end portion.

Thereby, the flow of the inert gas G can be reduced in the process of causing the inert gas G to flow in the flat part 43. Therefore, the flow of the inert gas G blown out from the blowing port 5b can be made more reliably to have a two-dimensional and uniform flow along a virtual plane extending in the vertical direction. Therefore, since occurrence of the circulating flow in the chamber 3 can be more reliably suppressed, fumes P1 and spatters P2 being caught in the circulating flow can be more satisfactorily suppressed. Therefore, the fumes P1 and the spatters P2 caught in the circulating flow blocking laser light L irradiated to an additive manufacturing article S can be more satisfactorily suppressed.

In the present embodiment, the blowing nozzle 40 includes the enlarged part 41 whose width in the second direction D2 becomes larger as it proceeds downward, and the outlet part 42 provided below the enlarged part 41 and extending downward with a constant width in the second direction D2. The blowing part 4 is provided at a lower end portion of the outlet part 42.

Thereby, the flow of the inert gas G can be aligned in the vertical direction in the process of causing the inert gas G to flow in the outlet part 42. Therefore, the inert gas G blown out from the blowing part 4 colliding with a side portion 30 to generate a circulating flow can be more reliably suppressed until it reaches the additive manufacturing area 13. Therefore, the fumes P1 and the spatters P2 being caught in the circulating flow can be more satisfactorily suppressed. Accordingly, the fumes P1 and the spatters P2 caught in the circulating flow blocking the laser light L irradiated to the additive manufacturing article S can be more satisfactorily suppressed.

In the present embodiment, the blowing nozzle 40 includes the plurality of guide vanes 46 aligned in the second direction D2 therein.

Thereby, the inert gas G can be more uniformly dispersed in the second direction 2 in the process of causing the inert gas G to flow between the plurality of guide vanes 46. Therefore, the flow of the inert gas G blown out from the blowing part 4 can be more reliably made to have a two-dimensional and uniform flow along a virtual plane extending in the vertical direction. Therefore, since occurrence of the circulating flow in the chamber 3 can be more reliably suppressed, the occurrence of the fumes P1 and the spatters P2 being caught in the circulating flow can be more satisfactorily suppressed. Accordingly, the fumes P1 and the spatters P2 caught in the circulating flow blocking the laser light L irradiated to the additive manufacturing article S can be more satisfactorily suppressed.

In the present embodiment, the blowing nozzle 40 includes the first blowing nozzle S1 attached to the ceiling portion main body 21, and the second blowing nozzle S2 connected to the first blowing nozzle S1 and extending downward from the first blowing nozzle S1 to have the blowing part 4.

Thereby, the additive manufacturing devices 1C and 1D having the blowing nozzle 40 can be obtained simply by attaching the second blowing nozzle S2 to the first blowing nozzle S1. That is, in a case of an existing nozzle in which the first blowing nozzle S1 has already been attached to the ceiling portion main body 21, the additive manufacturing device 1C having the blowing nozzle 40 can be obtained simply by additionally installing the second blowing nozzle.

Further, in the fourth embodiment, the width W1b of the blowing port 5b in the second direction D2 has been configured to be larger than the width W1a of the blowing port 5b in the first direction D1 and equal to or larger than the width W2 of the additive manufacturing area 13 in the second direction D2, but the present disclosure is not limited thereto.

The width W1b of the blowing port 5b in the second direction D2 may be larger than the width W1a of the blowing port 5b in the first direction D1 and may be equal to or larger than a width W4 of the additive manufacturing article S in the second direction D2. In this case, the same operation and effects as those of the second embodiment can be exhibited.

Also, the width W1a of the blowing port 5b in the first direction D1 may be smaller than a width W5a of the laser irradiation window 22 in the first direction D1, and the width W1b of the blowing port 5b in the second direction D2 may be larger than a width W5b of a first laser irradiation window 23 in the second direction D2. In this case, the same operation and effects as those of the third embodiment can be exhibited.

Further, in the fourth embodiment, the attachment opening 26 of the ceiling portion main body 21 and the introduction port 5a of the blowing nozzle 40 have been configured to be formed in a circular shape, but the present disclosure is not limited thereto, and may be formed in an elliptical shape.

Further, in the fourth embodiment, the blowing nozzle 40 has been configured to have the first blowing nozzle S1, but the present disclosure is not limited thereto and may be constituted only by the second blowing nozzle S2. In this case, the blowing nozzle 40 is attached in a form of being additionally installed in the additive manufacturing device which already has a nozzle (existing nozzle) for blowing out the inert gas G in the ceiling portion 20. The blowing nozzle 40 is attached to an opening at a lower end of the existing nozzle. Alternatively, the blowing nozzle 40 constituted only by the second blowing nozzle S2 may be attached to the attachment opening 26 of the ceiling portion main body 21 in place of the existing nozzle.

### Fifth Embodiment

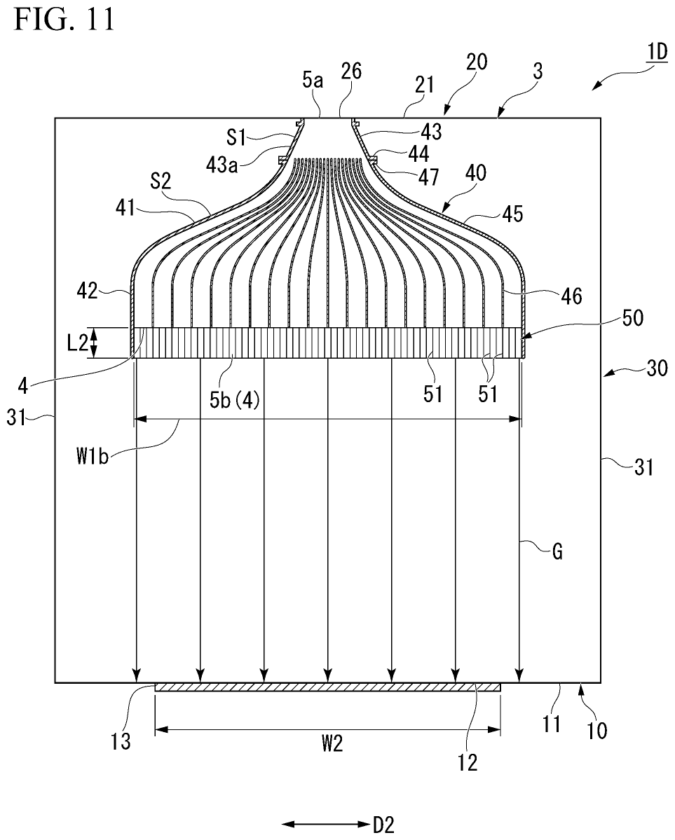

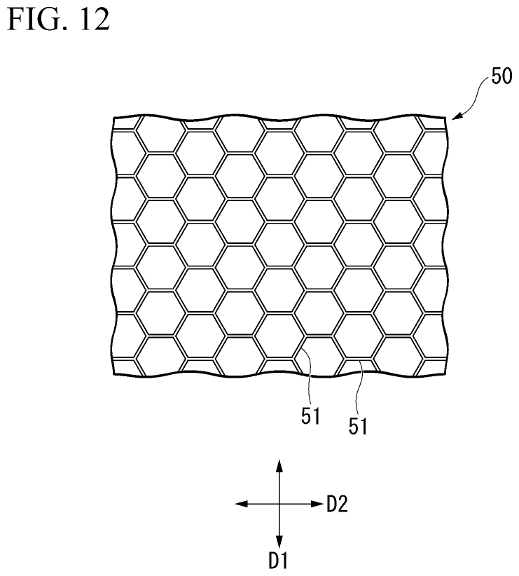

Hereinafter, an additive manufacturing device 1D according to a fifth embodiment of the present disclosure will be described with reference to FIGS. 11 and 12. In the fifth embodiment, components the same as those in the first embodiment will be denoted by the same reference signs and detailed description thereof will be omitted. Configurations of the fifth embodiment other than those described below are the same as the configurations of the fourth embodiment.

As illustrated in FIG. 11, the additive manufacturing device 1D includes a blowing nozzle 40 further having a rectifying member 50 (corresponding to a rectifying part in the claims) in addition to the blowing nozzle 40 of the fourth embodiment. The rectifying member 50 is provided inside a lower end portion 40b of the blowing nozzle 40. For example, the rectifying member 50 is provided inside a flat part 43 of the blowing nozzle 40. From another point of view, the rectifying member 50 is provided inside an outlet part 42 of the blowing nozzle 40. For example, the rectifying member 50 is provided below a plurality of guide vanes 46 inside the outlet part 42 of the blowing nozzle 40.

As illustrated in FIG. 12, the rectifying member 50 includes a plurality of rectifying tube parts 51 (corresponding to tube parts in the claims) therein. Cross-sectional shapes of the plurality of rectifying tube parts 51 are polygons (for example, regular hexagons) having the same size as each other. The plurality of rectifying tube parts 51 are disposed without gaps in a first direction D1 and a second direction D2.

A length L2 of the rectifying tube part 51 in a vertical direction is larger than, for example, a width W1a of a blowing port 5b in the first direction D1. The length L2 of the rectifying tube part 51 in the vertical direction is, for example, 5 mm or more. Also, from another point of view, the length of the rectifying tube part 51 in the vertical direction is three times or more a diagonal length of a regular hexagonal cross-sectional shape of the rectifying tube part 51.

(Operation and Effects)

In the present embodiment, the additive manufacturing device 1D includes a rectifying member 50 provided inside the blowing nozzle 40. The rectifying member 50 includes the plurality of rectifying tube parts 51 extending in the vertical direction.

Thereby, among flow components of the inert gas G, components of the first direction D1 and the second direction D2 can be attenuated in the process of causing the inert gas G to flow in the rectifying tube parts 51. Therefore, the inert gas G blown from a blowing part 4 diffusing in the first direction D1 and the second direction D2 can be further suppressed. Therefore, since a flow velocity of the inert gas G colliding with an additive manufacturing area 13 can be kept high, removal performance of fumes P1 and spatters P2 can be maintained.

Also, since components of the first direction D1 and the second direction D2 can be attenuated in the flow components of the inert gas G, a flow along the additive manufacturing area 13 is likely to be formed. Thereby, occurrence of a circulating flow in a chamber 3 can be more reliably suppressed. Therefore, the fumes P1 and the spatters P2 being caught in the circulating flow can be more satisfactorily suppressed. Accordingly, the fumes P1 and the spatters P2 caught in the circulating flow blocking laser light L irradiated to an additive manufacturing article S can be more satisfactorily suppressed.

Further, in the fifth embodiment, the rectifying member 50 has been configured to be provided in the blowing nozzle 40, but the present disclosure is not limited thereto. For example, the rectifying member 50 may be directly connected to the blowing opening 25 of the first to third embodiments.

Further, in the fifth embodiment, the rectifying member 50 may be formed integrally with the blowing nozzle 40 or may be a separate member from the blowing nozzle 40. If the rectifying member 50 is a separate member from the blowing nozzle 40, the rectifying member 50 is fixed with an upper end portion thereof inserted into the blowing part 4 of the blowing nozzle 40.

Further, in the fifth embodiment, the plurality of rectifying tube parts 51 have been configured to be disposed without gaps in the first direction D1 and the second direction D2, but the present disclosure is not limited thereto, and the plurality of rectifying tube parts 51 may be disposed to be aligned in at least one of the first direction D1 and the second direction D2.

Further, in the fifth embodiment, cross-sectional shapes of the plurality of rectifying tube parts 51 have been configured to be a regular hexagon, but the present disclosure is not limited thereto, and may be a regular triangle, a regular quadrangle, or the like.

### Other Embodiments

While embodiments of the present disclosure have been described in detail as above with reference to the accompanying drawings, the specific configurations are not limited to the embodiments but may include design changes or the like without departing from the gist of the present disclosure.

Further, the material powder has been configured to be a metal in the above-described embodiments, but the present disclosure is not limited thereto, and may be a resin material.

Further, the second direction D2 has been perpendicular to the first direction D1 in the above-described embodiments, but the present disclosure is not limited thereto, and may intersect the first direction D1. For example, the angle between the first direction D1 and the second direction D2 may be slightly larger or smaller than 90 degrees.

Further, the bottom portion 10 has been configured to have the stage 12 in the above-described embodiments, but the present disclosure is not limited thereto. The bottom portion 10 may not have the stage 12, and the additive manufacturing area 13 of the bottom portion 10 may be a plane that is not raised and lowered vertically.

In addition, in the above-described embodiments, the blowing part 4 has been configured to be formed in a rectangular shape extending in the second direction D2 in a plan view, but the present disclosure is not limited thereto. For example, the blowing part 4 may be formed in an elliptical shape extending in the second direction D2.

Further, the laser irradiation window 22 has been configured to be provided at a central part of the ceiling portion main body 21 in the above-described embodiments, but the present disclosure is not limited thereto, and the laser irradiation window 22 may be disposed to be biased in the first direction D1 or in the second direction D2 of the ceiling portion main body 21.

Further, four laser irradiation windows 22 have been provided in the above-described embodiments, but the present disclosure is not limited thereto, and only one laser irradiation window 22 may be provided. The number of laser irradiation windows 22 can be changed as appropriate.

Further, the laser irradiation window 22 has been formed in a disc shape in the above-described embodiments, but the present disclosure is not limited thereto. For example, the laser irradiation window 22 may be formed in a rectangular plate shape, and a shape of the laser irradiation window 22 is not limited.

<Additional Statement>

The additive manufacturing devices 1, 1A, 1B, 1C and 1D and the blowing nozzle 40 described in the embodiments are grasped, for example, as follows.

(1) Additive manufacturing devices 1, 1C and 1D according to a first aspect includes a bottom portion 10 having an additive manufacturing area 13 on which an additive manufacturing article S is additively manufactured, a ceiling portion 20 positioned above the bottom portion 10 and having a blowing part 4 for an inert gas G, a side portion 30 standing upward from a side end portion 11 of the bottom portion 10, and a discharge port 33 of the inert gas G, in which under a condition where a first direction D1 is oriented from the additive manufacturing area 13 toward the discharge port 33 in a direction parallel to the bottom portion 10 and a second direction D2 is oriented across the first direction D1 in the direction parallel to the bottom portion 10, a first width W1b of the blowing part 4 in the second direction D2 is larger than a second width W1a of the blowing part 4 in the first direction D1 and is equal to or larger than a third width W2 of the additive manufacturing area 13 in the second direction D2.

Thereby, in the blowing part 4, a flow of the inert gas G can be made uniform in the second direction D2 while being aligned in parallel. The flow of the inert gas G blown out from the blowing part 4 has a two-dimensional and uniform flow along a virtual plane extending in the vertical direction. Further, the inert gas G can be made to collide with the entire additive manufacturing area 13 in the second direction D2. The inert gas G that has collided with the additive manufacturing area 13 flows in the first direction D1 along the additive manufacturing area 13 and is discharged from the discharge port 33. The flow of the inert gas G along the additive manufacturing area 13 has a uniform flow. The fumes P1 and the spatters P2 can be discharged from the discharge port 33 by the flow of the inert gas G along the additive manufacturing area 13.

(2) Additive manufacturing devices 1, 1A, 1B, 1C and 1D of a second aspect include a bottom portion 10 having an additive manufacturing area 13 on which an additive manufacturing article S is additively manufactured, a ceiling portion 20 positioned above the bottom portion 10 and having a blowing part 4 for an inert gas G, a side portion 30 standing upward from a side end portion 11 of the bottom portion 10, and a discharge port 33 of the inert gas G, in which under a condition where a first direction D1 is oriented from the additive manufacturing area 13 toward the discharge port 33 in a direction parallel to the bottom portion 10 and a second direction D2 is oriented across the first direction D1 in the direction parallel to the bottom portion 10, a first width W1b of the blowing part 4 in the second direction D2 is larger than a second width W1a of the blowing part 4 in the first direction D1 and is equal to or larger than a third width W2 of the additive manufacturing article S in the second direction D2.

Thereby, in the blowing part 4, a flow of the inert gas G can be made uniform in the second direction D2 while being aligned in parallel. The flow of the inert gas G blown out from the blowing part 4 has a two-dimensional and uniform flow along a virtual plane extending in the vertical direction. Further, the inert gas G can be made to collide with the entire of the additive manufacturing article S in the second direction D2. The inert gas G that has collided with the additive manufacturing article S flows in the first direction D1 along the additive manufacturing area 13 and is discharged from a discharge port 33. The flow of the inert gas G along the additive manufacturing area 13 has a uniform flow at least in the area that is actually used for additive manufacturing. The fumes P1 and the spatters P2 can be discharged from the discharge port 33 by the flow of the inert gas G along the additive manufacturing area 13.

(3) Additive manufacturing devices 1, 1A, 1B, 1C and 1D of a third aspect include a bottom portion 10 having an additive manufacturing area 13 on which an additive manufacturing article S is additively manufactured, a ceiling portion 20 positioned above the bottom portion 10 and having a blowing part 4 for an inert gas G and a first laser irradiation window 23, a side portion 30 standing upward from a side end portion 11 of the bottom portion 10, and a discharge port 33 of the inert gas G, in which under a condition where a first direction D1 is oriented from the additive manufacturing area 13 toward the discharge port 33 in a direction parallel to the bottom portion 10 and a second direction D2 is oriented across the first direction D1 in the direction parallel to the bottom portion 10, a first width W1a of the blowing part 4 in the first direction D1 is smaller than a second width W5a of the first laser irradiation window 23 in the first direction D1, and a width W1b of the blowing part 4 in the second direction D2 is larger than a third width W5b of the first laser irradiation window 23 in the second direction D2.

Thereby, in the blowing part 4, a flow of the inert gas G can be made uniform in the second direction D2 while being aligned in parallel. The flow of the inert gas G blown out from the blowing part 4 has a two-dimensional and uniform flow along a virtual plane extending in the vertical direction. Further, since the inert gas G can be blown out from a wider range in the second direction D2 than the width W5b of the first laser irradiation window 23 in the second direction D2, the inert gas G can be made to collide with a wider range in the second direction D2 than an area of the additive manufacturing area 13 that overlaps the first laser irradiation window 23. The inert gas G that has collided with the additive manufacturing area 13 flows in the first direction D1 along the additive manufacturing area 13 and is discharged from the discharge port 33. The flow of the inert gas G along the additive manufacturing area 13 has a uniform flow at least in the area of the additive manufacturing area 13 that overlaps the first laser irradiation window 23. The fumes P1 and the spatters P2 can be discharged from the discharge port 33 by the flow of the inert gas G along the additive manufacturing area 13.

(4) Additive manufacturing devices 1, 1A, 1B, 1C and 1D of a fourth aspect are described in the additive manufacturing devices 1, 1A, 1B, 1C and 1D of the third aspect, in which the ceiling portion 20 may include a second laser irradiation window 24 in which at least part thereof is aligned with the first laser irradiation window 23 in the second direction D2, and the blowing part 4 may include a first portion 4a aligned with the first laser irradiation window 23 in the first direction D1 and a second portion 4b aligned with the second laser irradiation window 24 in the first direction D1 in a plan view of the additive manufacturing devices 1, 1A, 1B, 1C and 1D.

Thereby, the inert gas G can be blown out from a wide range corresponding to a region in which the first laser irradiation window 23 and the second laser irradiation window 24 are provided. Therefore, the inert gas G can be made to collide with a wide range of the additive manufacturing area 13 corresponding to the first laser irradiation window 23 and the second laser irradiation window 24.

(5) Additive manufacturing devices 1, 1A, 1B, 1C and 1D of a fifth aspect are described in the additive manufacturing devices 1, 1A, 1B, 1C and 1D according to any one of the first to fourth aspects, in which at least one of the bottom portion 10, the side portion 30, a flow path member 34 provided separately from the bottom portion 10 and the side portion 30 may include the discharge port 33.

(6) Additive manufacturing devices 1, 1A and 1B of a sixth aspect are described in the additive manufacturing devices 1, 1A and 1B according to any one of the first to fifth aspects, in which the ceiling portion 20 may include a ceiling portion main body 21 that partitions a space vertically, and the blowing part 4 may be an opening (blowing opening 25) provided in the ceiling portion main body 21.

Thereby, the blowing part 4 can be formed by simple processing of simply forming the opening (blowing opening 25) in the ceiling portion main body 21.

(7) Additive manufacturing devices 1C and 1D according to a seventh aspect are described in the additive manufacturing devices 1C and 1D according to any one of the first to fifth aspects, in which the ceiling portion 20 may include a ceiling portion main body 21 that partitions a space vertically and a blowing nozzle 40 extending downward from the ceiling portion main body 21, and the blowing part 4 may be an opening (blowing port 5b) provided at a lower end portion of the blowing nozzle 40.

Thereby, the additive manufacturing devices 1C and 1D including the blowing part 4 (the blowing port 5b) can be obtained by attaching the blowing nozzle 40 to the ceiling portion main body 21.

(8) Additive manufacturing devices 1C and 1D of a eighth aspect are described in the additive manufacturing devices 1C and 1D of the seventh aspect, in which the blowing nozzle 40 may include a flat part 43 extending in the second direction D2 at least at the lower end portion.

Thereby, a flow of the inert gas G can be reduced in the process of causing the inert gas G to flow in the flat part 43. Therefore, the flow of the inert gas G blown out from the blowing port 5b can be more reliably made to have a two-dimensional and uniform flow along a virtual plane extending in the vertical direction.

(9) Additive manufacturing devices 1C and 1D of an ninth aspect are described in the additive manufacturing devices 1C and 1D of the seventh or eighth aspect, in which the blowing nozzle 40 may include an enlarged part 41 whose width in the second direction D2 becomes larger as it proceeds downward and an outlet part 42 provided below the enlarged part 41 and extending downward with a constant width in the second direction D2, and the blowing part 4 may be provided at a lower end portion of the outlet part 42.

Thereby, a flow of the inert gas G can be aligned in the vertical direction in the process of causing the inert gas G to flow in the outlet part 42. Therefore, the inert gas G blown out from the blowing part 4 colliding with the side portion 30 to generate a circulating flow can be more reliably suppressed until it reaches the additive manufacturing area 13.

(10) Additive manufacturing devices 1C and 1D of a tenth aspect are described in the additive manufacturing devices 1C and 1D according to any one of the seventh to ninth aspects, in which the blowing nozzle 40 may include a plurality of guide vanes 46 aligned in the second direction D2 therein.

Thereby, the inert gas G can be uniformly dispersed in the second direction 2 in the process of causing the inert gas G to flow between the plurality of guide vanes 46. Therefore, the flow of the inert gas G blown out from the blowing part 4 can be more reliably made to have a two-dimensional and uniform flow along a plane extending in the vertical direction.

(11) An additive manufacturing device 1D according to a eleventh aspect is described in the additive manufacturing device 1D according to any one of the seventh to tenth aspects, in which the blowing nozzle 40 may include a rectifying part (rectifying member 50), and the rectifying part may include a plurality of tube parts (rectifying tube parts 51) disposed to be aligned in at least one of the first direction D1 and the second direction D2 and each extending in the vertical direction.

Thereby, among flow components of the inert gas G, at least one component of the first direction D1 and the second direction D2 can be attenuated in the process of causing the inert gas G to flow in the rectifying tube parts 51. Therefore, the inert gas G blown from the blowing part 4 diffusing in the first direction D1 or the second direction D2 can be further suppressed.

(12) Additive manufacturing devices 1C and 1D of an twelfth aspect are described in the additive manufacturing devices 1C and 1D according to any one of the seventh to eleventh aspect, in which the blowing nozzle 40 may include a first blowing nozzle S1 attached to the ceiling portion main body 21, and a second blowing nozzle S2 connected to the first blowing nozzle S1 and extending downward from the first blowing nozzle S1 to have the blowing part 4.

Thereby, the additive manufacturing devices 1C and 1D including the blowing nozzle 40 can be obtained simply by attaching the second blowing nozzle S2 to the first blowing nozzle S1.

(13) A blowing nozzle 40 of a thirteenth aspect is attachable to the additive manufacturing devices 1C and 1D and includes a first end portion (upper end portion 40a) including an introduction part (introduction port 5a) of an inert gas G, and a second end portion (lower end portion 40b) positioned on a side opposite to the first end portion and including a blowing part 4 (blowing port 5b) for the inert gas, in which, under a condition where a first direction D1 is oriented in a direction parallel to the second end portion and a second direction D2 is oriented across the first direction D1 in the direction parallel to the second end portion, the blowing nozzle 40 includes a flat part 43 extending in the second direction D2 at least at the second end portion, and a first width W1b of the blowing part 4 in the second direction D2 is larger than a second width W1a of the blowing part 4 in the first direction D1.

### EXPLANATION OF REFERENCES

1, 1A, 1B, 1C, 1D Additive manufacturing device
2 Laser irradiation unit
3 Chamber
4 Blowing part
4a First portion
4b Second portion
5a Introduction port (introduction part)
5b Blowing port (opening)
10 Bottom portion
11 Side end portion
12 Stage
13 Additive manufacturing area
14 Use area
20 Ceiling portion
21 Ceiling portion main body
22 Laser irradiation window
23 First laser irradiation window
24 Second laser irradiation window
25 Blowing opening (opening)
26 Attachment opening
30 Side portion
31 First side portion
32 Second side portion
33 Discharge port
34 Flow path member
40 Blowing nozzle
40a Upper end portion (first end portion)
40b Lower end portion (second end portion)
41 Enlarged part
42 Outlet part
43 Flat part
43a First blowing nozzle main body
44 Flange
45 Second blowing nozzle main body (flat part main body)
46 Guide vane
47 Flange
50 Rectifying member (rectifying part)
51 Rectifying tube part (tube part)
D1 First direction
D2 Second direction
G Inert gas
L Laser light
L1 Length of outlet part in vertical direction
L2 Length of rectifying tube part in vertical direction
P1 Fume
P2 Spatter
S Additive manufacturing article
S1 First blowing nozzle
S2 Second blowing nozzle
W1a Width of blowing part in first direction
W1b Width of blowing part in second direction
W2 Width of additive manufacturing area in second direction
W3 Width of discharge port in second direction
W4 Width of additive manufacturing article in second direction
W5a Width of first laser irradiation window in first direction
W5b Width of first laser irradiation window in second direction
W6a Width of introduction part in first direction
W6b Width of introduction part in second direction

What is claimed is:

1. An additive manufacturing device comprising:
a bottom portion having an additive manufacturing area on which an additive manufacturing article is additively manufactured;
a ceiling portion positioned above the bottom portion and having a blowing part for an inert gas;
a side portion standing upward from a side end portion of the bottom portion; and
a discharge port of the inert gas, wherein
under a condition where a first direction is oriented from the additive manufacturing area toward the discharge port in a direction parallel to the bottom portion and a second direction is oriented across the first direction in the direction parallel to the bottom portion, a first width of the blowing part in the second direction is larger than a second width of the blowing part in the first direction and is equal to or larger than a third width of the additive manufacturing area in the second direction.

2. An additive manufacturing device comprising:
a bottom portion having an additive manufacturing area on which an additive manufacturing article is additively manufactured;
a ceiling portion positioned above the bottom portion and having a blowing part for an inert gas;
a side portion standing upward from a side end portion of the bottom portion; and
a discharge port of the inert gas, wherein
under a condition where a first direction is oriented from the additive manufacturing area toward the discharge port in a direction parallel to the bottom portion and a second direction is oriented across the first direction in the direction parallel to the bottom portion, a first width of the blowing part in the second direction is larger than a second width of the blowing part in the first direction and is equal to or larger than a third width of the additive manufacturing article in the second direction.

3. An additive manufacturing device comprising:
a bottom portion having an additive manufacturing area on which an additive manufacturing article is additively manufactured;
a ceiling portion positioned above the bottom portion and having a blowing part for an inert gas and a first laser irradiation window;
a side portion standing upward from a side end portion of the bottom portion; and
a discharge port of the inert gas, wherein
under a condition where a first direction is oriented from the additive manufacturing area toward the discharge port in a direction parallel to the bottom portion and a second direction is oriented across the first direction in the direction parallel to the bottom portion, a first width of the blowing part in the first direction is smaller than a second width of the first laser irradiation window in the first direction, and a width of the blowing part in the second direction is larger than a third width of the first laser irradiation window in the second direction.

4. The additive manufacturing device according to claim 3, wherein
the ceiling portion includes a second laser irradiation window in which at least part thereof is aligned with the first laser irradiation window in the second direction, and
the blowing part includes a first portion aligned with the first laser irradiation window in the first direction and a second portion aligned with the second laser irradiation window in the first direction in a plan view of the additive manufacturing device.

5. The additive manufacturing device according to claim 1, wherein at least one of the bottom portion, the side portion, and a flow path member provided separately from the bottom portion and the side portion includes the discharge port.

6. The additive manufacturing device according to claim 2, wherein at least one of the bottom portion, the side portion, and a flow path member provided separately from the bottom portion and the side portion includes the discharge port.

7. The additive manufacturing device according to claim 3, wherein at least one of the bottom portion, the side portion, and a flow path member provided separately from the bottom portion and the side portion includes the discharge port.

8. The additive manufacturing device according to claim 1, wherein
the ceiling portion includes a ceiling portion main body which partitions a space vertically, and
the blowing part is an opening provided in the ceiling portion main body.

9. The additive manufacturing device according to claim 2, wherein
the ceiling portion includes a ceiling portion main body which partitions a space vertically, and
the blowing part is an opening provided in the ceiling portion main body.

10. The additive manufacturing device according to claim 3, wherein
the ceiling portion includes a ceiling portion main body which partitions a space vertically, and
the blowing part is an opening provided in the ceiling portion main body.

11. The additive manufacturing device according to claim 1, wherein
the ceiling portion includes a ceiling portion main body which partitions a space vertically and a blowing nozzle extending downward from the ceiling portion main body, and
the blowing part is an opening provided at a lower end portion of the blowing nozzle.

12. The additive manufacturing device according to claim 2, wherein
the ceiling portion includes a ceiling portion main body which partitions a space vertically and a blowing nozzle extending downward from the ceiling portion main body, and
the blowing part is an opening provided at a lower end portion of the blowing nozzle.

13. The additive manufacturing device according to claim 3, wherein
the ceiling portion includes a ceiling portion main body which partitions a space vertically and a blowing nozzle extending downward from the ceiling portion main body, and
the blowing part is an opening provided at a lower end portion of the blowing nozzle.

14. The additive manufacturing device according to claim 11, wherein the blowing nozzle includes a flat part extending in the second direction at least at the lower end portion.

15. The additive manufacturing device according to claim 12, wherein the blowing nozzle includes a flat part extending in the second direction at least at the lower end portion.

16. The additive manufacturing device according to claim 13, wherein the blowing nozzle includes a flat part extending in the second direction at least at the lower end portion.

17. The additive manufacturing device according to claim 11, wherein
the blowing nozzle includes an enlarged part whose width in the second direction becomes larger as it proceeds downward and an outlet part provided below the enlarged part and extending downward with a constant width in the second direction, and
the blowing part is provided at a lower end portion of the outlet part.

18. The additive manufacturing device according to claim 12, wherein
the blowing nozzle includes an enlarged part whose width in the second direction becomes larger as it proceeds downward and an outlet part provided below the enlarged part and extending downward with a constant width in the second direction, and
the blowing part is provided at a lower end portion of the outlet part.

19. The additive manufacturing device according to claim 13, wherein
the blowing nozzle includes an enlarged part whose width in the second direction becomes larger as it proceeds downward and an outlet part provided below the enlarged part and extending downward with a constant width in the second direction, and
the blowing part is provided at a lower end portion of the outlet part.

20. The additive manufacturing device according to claim 11, wherein the blowing nozzle includes a plurality of guide vanes aligned in the second direction therein.

21. The additive manufacturing device according to claim 12, wherein the blowing nozzle includes a plurality of guide vanes aligned in the second direction therein.

22. The additive manufacturing device according to claim 13, wherein the blowing nozzle includes a plurality of guide vanes aligned in the second direction therein.

23. The additive manufacturing device according to claim 11, wherein
the blowing nozzle includes a rectifying part, and
the rectifying part includes a plurality of tube parts disposed to be aligned in at least one of the first direction and the second direction and each extending in the vertical direction.

24. The additive manufacturing device according to claim 12, wherein
the blowing nozzle includes a rectifying part, and
the rectifying part includes a plurality of tube parts disposed to be aligned in at least one of the first direction and the second direction and each extending in the vertical direction.

25. The additive manufacturing device according to claim 13, wherein
the blowing nozzle includes a rectifying part, and
the rectifying part includes a plurality of tube parts disposed to be aligned in at least one of the first direction and the second direction and each extending in the vertical direction.

26. The additive manufacturing device according to claim 11, wherein the blowing nozzle includes a first blowing nozzle attached to the ceiling portion main body, and a second blowing nozzle connected to the first blowing nozzle and extending downward from the first blowing nozzle to have the blowing part.

27. The additive manufacturing device according to claim 12, wherein the blowing nozzle includes a first blowing nozzle attached to the ceiling portion main body, and a second blowing nozzle connected to the first blowing nozzle and extending downward from the first blowing nozzle to have the blowing part.

28. The additive manufacturing device according to claim 13, wherein the blowing nozzle includes a first blowing nozzle attached to the ceiling portion main body, and a second blowing nozzle connected to the first blowing nozzle and extending downward from the first blowing nozzle to have the blowing part.

29. A blowing nozzle which is attachable to an additive manufacturing device, the blowing nozzle comprising:
a first end portion including an introduction part of an inert gas; and
a second end portion positioned on a side opposite to the first end portion and including a blowing part for the inert gas, wherein,
under a condition where a first direction is oriented in a direction parallel to the second end portion and a second direction is oriented across the first direction in the direction parallel to the second end portion,
the blowing nozzle includes a flat part extending in the second direction at least at the second end portion, and
a first width of the blowing part in the second direction is larger than a second width of the blowing part in the first direction.
